(19) United States
(12) Patent Application Publication
(10) Pub. No.: US 2009/0262667 A1
(43) Pub. Date: Oct. 22, 2009

(54) SYSTEM AND METHOD FOR ENABLING TOPOLOGY MAPPING AND COMMUNICATION BETWEEN DEVICES IN A NETWORK

(75) Inventor: Osamu KOBAYASHI, Los Altos, CA (US)

Correspondence Address: STMICROELECTRONICS, INC., MAIL STATION 2346 , 1310 ELECTRONICS DRIVE, CARROLLTON, TX, 75006, US

(73) Assignee: STMICROELECTRONICS, INC., Carrollton, TX (US)

(21) Appl. No.: 12/423,724

(22) Filed: Apr. 14, 2009

Related U.S. Application Data
(60) Provisional application No. 61/046,618, filed on Apr. 21, 2008.

(51) Int. Cl. H04L 12/28

(52) U.S. Cl. 370/254

(57) ABSTRACT

Methods and systems are described for discovering network topology in a multimedia network. Further the invention describes methods and systems for establishing synchronization between multiple nodes in a multimedia network. Also, disclosed are message transmission systems and methodology using relative path addressing to guide and direct messages in a multimedia network.

### CROSS-REFERENCE TO RELATED APPLICATIONS

This patent application claims the benefit of priority under 35 U.S.C. 119(e) to U.S. Provisional Patent Application Ser. No. 61/046,618 (Attorney Docket No. GENSP204P) filed Apr. 21, 2008 and entitled “High Speed Aux (HS_AUX) and Isochronous Transport Support Over Aux” which is hereby incorporated by reference herein for all purposes.

This patent application is also related to U.S. patent application Ser. No. 10/726,794 (Attorney Docket No. GENSP013) filed Dec. 2, 2003 and entitled “PACKET BASED VIDEO DISPLAY INTERFACE AND METHODS OF USE THEREOF,” and U.S. patent application Ser. No. 10/762,680 (Attorney Docket No. GENSP047) filed Jan. 21, 2004 and entitled “PACKET BASED HIGH DEFINITION HIGH-BANDWIDTH DIGITAL CONTENT PROTECTION,” both of which are hereby incorporated by reference herein for all purposes.

### TECHNICAL FIELD

The present invention relates generally to the networking of devices and the communication of messages in such networks. More particularly, methods, software, hardware, and systems are described for navigating messages in complex network topologies in a multimedia network.

### BACKGROUND OF THE INVENTION

Currently, multimedia networks are relatively simple. One or two sources routed into a display device. Such simple networks have not imposed significant burdens on message traffic in multimedia networks. However, advances in multimedia components and increased sophistication in network architectures and device capabilities had made for an increasing need to support a wide range of device capabilities and intricate network interconnection paths. Particularly, there is a need for an adaptive and flexible method and system for establishing messaging synchronization between the various devices connected to a network. Moreover, there is need for an expandable, adaptable, and flexible way to define communication paths between the devices in a network. Additionally, there is a need for methods and systems capable of mapping a network topology in a manner that is quick, adaptable, flexible, and capable of defining relative paths between a changing multitude of interconnected devices on a network.

While existing systems and methods work well for many applications, there is an increasing demand for more a more flexible system with far greater capacity to fully enjoy the benefits of modern multimedia equipments, software and devices. The disclosure addresses some of those needs.

### SUMMARY OF THE INVENTION

In one aspect, an integrated circuit package configured to operate in a networked multi-media device is described. The package comprises message transport circuitry, destination determination circuitry, address processing circuitry, and at least one communication line. The message transport circuitry adapted to transmit and receive data messages. The at least one communication line coupled with said message transport circuitry and each line having a unique port identifier. Moreover, each communication line is commonly associated with a communication interface (e.g., a comm. Port) of a multi-media device. The destination determination circuitry processes received data messages to determine whether the present device is the intended final destination. Address processing circuitry modifies relative path address associated with said data messages received by the device. Further aspects of the device include a topology mapping module for initiating and conducting the mapping of a network address space for a network that the device forms part of. Aspects of the device also include a synchronization module used for determining timing and priority schemes for messages propagation in the network. Embodiments of this module are quite flexible allowing many different priority schemes as well as on-the-fly adjustment and “hot plug” adjustment enabled by the addition (or removal) of new devices.

The invention further including a method of providing control of data messaging in a network environment, such a method can include computer executable instructions for receiving a data message from the network, the message including a relative path address that defines a message propagation path through the network enabling the message to reach a final destination. The instructions further include modifying the relative path address of the data message to reflect the fact that the data message has moved from a prior location and reached a current location. Continuing computed instructions determine whether the current network location is the final destination for the message. In cases where the current location is the final destination, further processing can be performed. Examples of such processing include, but are not limited to, extracting a message payload from the data message and responding to the information within the message payload, sending an acknowledge message using the modified relative path address, confirming that the message is valid and uncorrupted, and many other post receipt activities. In the case where the message is not yet at the final destination, further instruction are executed. The modified relative path address of the data message is further accessed to determine a next destination for the message. Then instructions are performed for transmitting the data message through a departure port specified by the modified relative path address. The process can be continued until the final destination is reached.

A further aspect of the invention includes the initiation and execution of a network topology mapping process. Such an embodiment includes device and chip architecture and functionality as well is a supporting methodology as well as a supporting set of computer executable instructions. A device aspect of the invention includes topology discovery circuitry and methodologies adapted to map an address space for at least a portion of a network coupled with the device. In such aspect a networked device establishes a communication channel for each interface connected with an active network apparatus of the network. Topology discovery circuitry of the device receives topology information from each connected device interface, to include relative path addresses for active network apparatuses in communication with said interfaces. Then the topology discovery circuitry transmits the topology information to at least some interfaces connected with the network. Said topology information including, but not limited to said relative path addresses, are transmitted to other devices in the network. Thus a large picture of network topology is generated, enabling data message transmission to remote network apparatus using an associated relative path address. Commonly, device attributes, capabilities, and other device information are associated with the topology information by the topology discovery circuitry enabling a network to be further characterized by device capability.

General aspects of the invention include, but are not limited to methods, systems, apparatus, and computer program products for enabling message transmission in multimedia device networks. Aspects include message synchronization, message and device priority schemes, and dynamic adjustment of such priority schemes depending on changing network conditions as well as other circumstances. Moreover, the invention further includes methods, systems, apparatus, and computer program products for enabling topology discovery circuitry processes for characterizing the nature of device networks.

### BRIEF DESCRIPTION OF THE DRAWINGS

The invention and the advantages thereof may best be understood by reference to the following description taken in conjunction with the accompanying drawings in which:

FIG. 1A illustrates an embodiment of a multi-media network in accordance with the principles of the invention.

FIG. 1B illustrates a series of example branch devices suitable for implementation with the disclosed embodiments of the invention. The inventor specifically contemplates that branch devices other than those depicted here are suitable for use with the invention.

FIG. 2 illustrates an example link embodiment suitable for use in the networks described herein.

FIG. 3 illustrates a timing diagram showing one invention compatible timing scheme showing suitable “heartbeat” and “micro-beat” message transmission periods.

FIGS. 4A-4C illustrate an extremely simplified network embodiment and an associated timing and synchronization scheme used in accordance with the principles of the invention.

FIGS. 4D-4E illustrate another extremely simplified network embodiment and an associated timing and synchronization scheme used in accordance with the principles of the invention.

FIGS. 5A-5B illustrate another simplified network embodiment and an associated timing and synchronization scheme used in accordance with the principles of the invention.

FIG. 6 is a flow diagram illustrating one approach to timing and synchronization in a multi-media network in accordance with the principles of the invention.

FIG. 7 is a network diagram illustrating a multi-media network suitable for use in accordance with the principles of the invention.

FIG. 8 is a schematic depiction of an electronic system embodiment capable of executing the messaging processes and topology mapping processes described with respect to the invention.

FIG. 9 is table illustrating how messages can be transmitted through the devices of a network in accord with an embodiment of the invention. The table shows an approach to updated relative mapping and the tracking of “hop count”.

FIG. 10 is a flow diagram illustrating a process for transmitting messages to various devices in a multi-media network.

FIGS. 11A-11B illustrate one example message embodiment including an listing of some possible header field suitable for employment with embodiments of the invention.

FIG. 12 is a flow diagram illustrating a process for performing topology discovery for devices in a multi-media network.

In the drawings, like reference numerals are sometimes used to designate like structural elements. It should also be appreciated that the depictions in the figures are diagrammatic and not to scale.

### DETAILED DESCRIPTION OF EXAMPLE EMBODIMENTS

The present invention relates generally to multimedia network topology discovery and inter-device communication. Such invention includes the systems, circuit apparatus, software, and devices configured to enable the same. More particularly, methods and systems are described for defining messaging methodologies and defining network topology.

In the following description, numerous specific details are set forth to provide a thorough understanding of the present invention. It will be apparent, however, to one skilled in the art that the present invention may be practiced without some or all of these specific details. In other instances, well known process steps have not been described in detail in order to avoid unnecessary obscuring of the present invention.

The following description focuses on multimedia network embodiments and their modes of operation. Such networks having one or more multimedia sources networked with one or more sink devices (e.g., displays). Typical sources may include, but are not limited to any suitable video, audio, and/or data source device including a desktop computer, portable computer, DVD player, Blu-ray player, music player, set-top box or video graphics card, among a myriad of other multi-media content transmitting devices. Generally, the sink devices are those devices which consume the multimedia source information provided by source devices. Examples include, but are not limited to video displays, audio devices, computers, and a vast array of other multi-media consumption devices. Such displays, for example, can include analog and digital displays, computer display monitors, LCD televisions, plasma televisions, and many other display monitors. In various embodiments, the video source and display devices can include some sort of digital copy protection such as that described in, by way of example, U.S. patent application Ser. No. 10/762,680 filed Jan. 21, 2004 (Attorney Docket No. GENSP047), which is incorporated by reference herein. Additionally, the described embodiments are particularly well-suited for use with high-definition (HD) content.

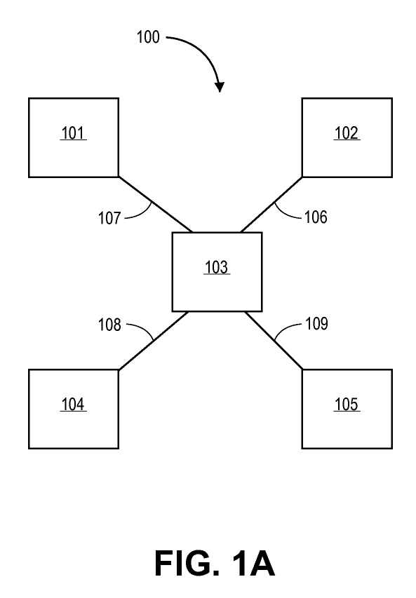

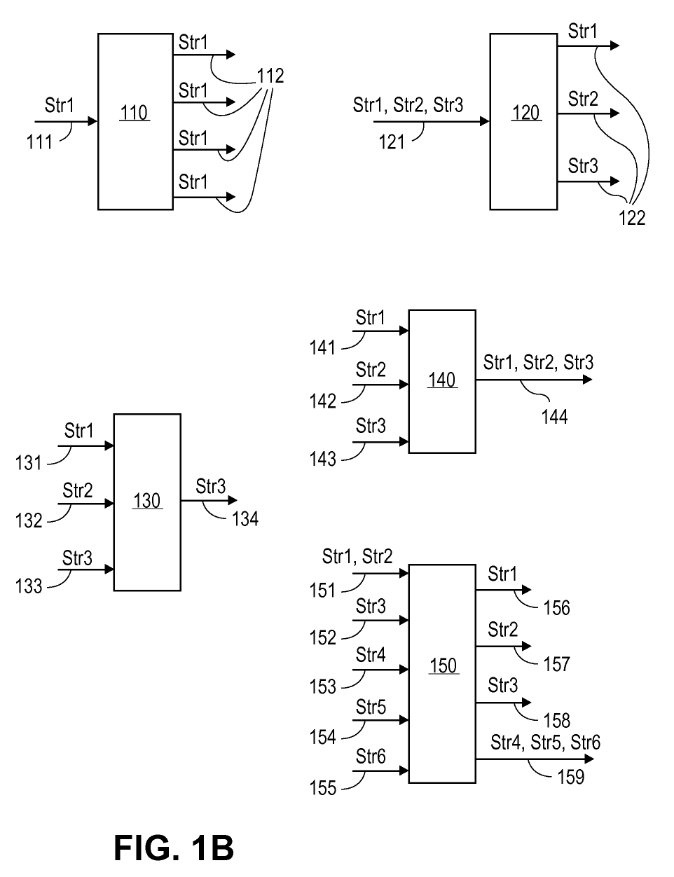

FIG. 1A illustrates an example network 100 comprising a variety of interlinked components such as multimedia components 101-105. In the depicted embodiment, the network 100 features a number of source devices 101, 102 coupled with a plurality of sink devices 104, 105 via a branch device 103.

Source devices 101, 102 in accordance with the principles of the invention comprise any device capable of producing a signal. Audio, video, and multimedia source devices are particularly suitable examples of device implementable with the present invention. Particular source embodiments include, but are not limited to set top boxes, DVD players, computers, HD video devices, VCR devices, radio, satellite boxes, music players, and many other such source devices beyond those referenced above. As stated above, suitable sink devices 104, 105 can comprise any device capable of consuming a source signal. Particularly suitable are devices capable of consuming audio, video, or other multimedia signals. Such embodiments include, but are not limited to audio devices, display devices, stereo equipment, receivers, and many other such source devices. Branch devices include, but are not limited to multimedia hubs, splitters, concentrators, switchable devices with many inputs and fewer outputs, replicators, concentrators, and many other types of branch devices that can link various combinations of components together.

FIG. 1B illustrates a number of specific examples of such branch devices. For example, a “replicator” 110 receives an input signal (e.g., Stream 1, received, for example, from a single input line 111) and outputs a plurality output signals, each substantially identical to the input signal (for example, outputting the signals using several different output lines 112). A “splitter” 120 includes, for example a single input line 121 carrying an input signal comprising, for example, several different data streams (e.g, Streams 1, 2, & 3) and outputs the streams (or various combinations of streams) into several different output lines 122. Another such branch is a “switch” type device 130. The switch 130 receives plurality of input signals (for example, Streams 1, 2, & 3) which are input using a plurality of input lines 131, 132, 133. An output signal (or more than one output signal) is output through associated output lines. In the depicted example, the switch 130 selects Stream 3 as the output signal using a single line 134. Another common branch device is a “concentrator” type device 140. The concentrator 140 receives plurality of input signals (for example, Streams 1, 2, & 3) input using a plurality of input lines 141, 142, 143. The input signals are concentrated into one or more output lines to provide a concentrated output signal. In the depicted example, the concentrator 140 concentrates input Streams 1, 2, & 3 into an single output signal comprising all of the Streams 1, 2, & 3 transmitted using a single line 144. In another common branch device, a “hub” device 150 is shown and described. A hub device 150 typically includes a plurality of input lines 151-155 and a plurality of output lines 156-159. The hub 150 enables input signals received from selected input lines to be output using selected output lines. Advantageously, such line and signal connections are adjustable as needed. In the depicted embodiment, Streams 1 & 2 are input using line 151, and Streams 3, 4, 5, & 6 using lines 152, 153, 154, 155 respectively. These input streams are reconfigured, for example, with Streams 1, 2, & 3 being output using lines 156, 157, 158 respectively, and Streams 4, 5, & 6 output through line 159. The inventor points out that other types of branch devices are contemplated by the inventor. Moreover, the inventor points out that all such features of the source, sink, and branch devices can be integrated into single devices having the characteristics of two or more of such devices. For example, a display can include a branch device such as a splitter and so on.

Returning to the embodiment illustrated in FIG. 1A, the components 101-105 are coupled with one another in a hub type network. This is an example and the invention is in no way limited to such constructions. Each of the connected components is interconnected using communication links 106, 107, 108 and 109. In a particular embodiment, each of the links 106-109 is configured for packet-based digital transport such as that described in, by way of example, U.S. patent application Ser. No. 10/726,794 (Attorney Docket No. GENSP013) which is incorporated by reference herein.

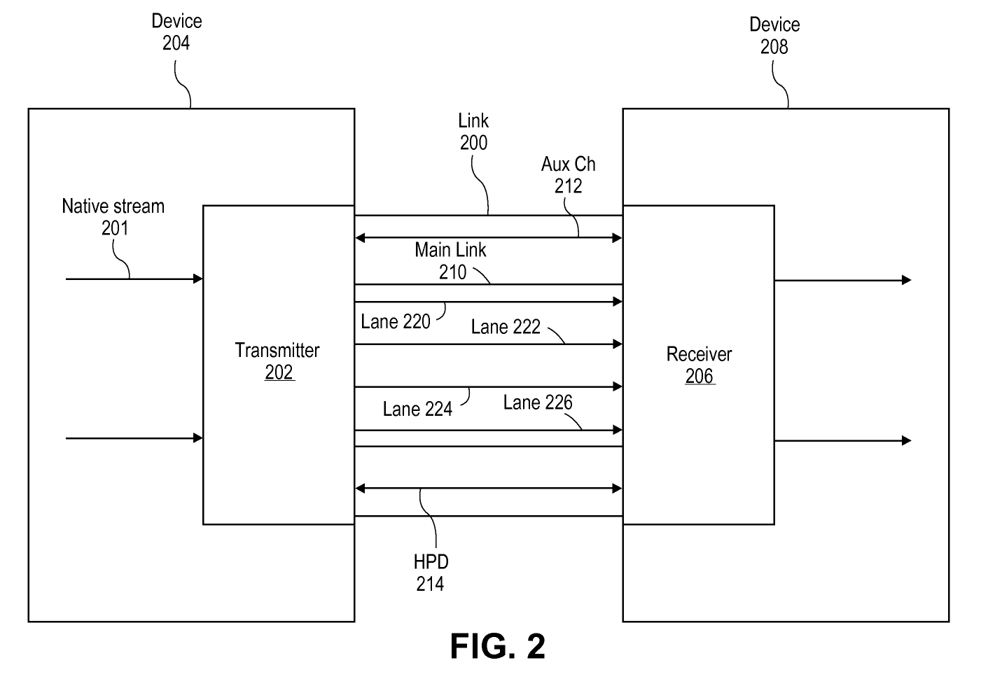

FIG. 2 illustrates a general link 200 that can be used in various embodiments of the present invention. By way of example, link 200 may be suitable for use as any one of links 106, 107, 108, and/or 109. In the illustrated embodiment, link 200 connects a transmitter interface 202 of a first device 204 with a receiver interface 206 at a second device 208.

Such a link 200 may include a uni-directional main link 210 for transporting isochronous streams downstream (e.g., from a source device to a display device). Such a link can have high bandwidth low latency channels. By way of example, the streams may comprise audio and video packets. In one example embodiment, the main link 210 can generally be configured to support 1, 2 or 4 data pairs, also referred to herein as lanes or channels. In the illustrated embodiment, main link 210 supports four lanes 220, 222, 224 and 226. Generally, source and display devices are allowed to support the minimum number of lanes required for their needs. By way of example, devices that support two lanes can be required to support both one and two lanes. Similarly, devices that support four lanes can be required to support 1, 2 and 4 lanes. Such a link can have high bandwidth low latency channels. In one implementation, link rates of 2.7 Gbs/channel or higher can be implemented. Additionally, certain implementations can be configured so than there is no dedicated clock channel. In such situations the link clock can be extracted from the data streams themselves. Once example of suitable encoding is ANSI 8B/10B coding (as outlined in ANSI X3.230-1994, clause 11) and other coding schemes.

In addition to main link 210, link 200 also includes a bi-directional auxiliary channel 212. Auxiliary channel 212 may be configured for half-duplex communication between coupled devices 204 and 208 connected with link 200. In an example embodiment, auxiliary channel 212 is utilized for link management and device control. In other implementations the auxiliary channel 212 may be configured for full duplex communication. Link 200 may also include a hot plug detect (HPD) signal line 214 for detecting when an active display device is coupled with the source device thus facilitating robust “plug-n-play” ease of use. The HPD signal can serve as an interrupt request by a display device. In some embodiments, a source device (e.g., source 101 which can be a video source device) can serve as a master device with a display device (e.g., sinks 104, 105 which can be displays) serving as a slave. As such, transactions over the auxiliary channel 212 are generally initiated by the source device. However, display devices and branch devices may also initiate communication with other connected components. In one approach, a display may prompt the initiation of a transaction over the auxiliary channel 212 by sending an interrupt request (IRQ) to the source device by toggling the HPD signal 214. Sources of device intercommunication will be discussed in greater detail in the following paragraphs.

### Device Message Timing and Synchronization

Referring again to the extremely simplified network 100 of FIG. 1A, the efficiency of messaging between the various components 101-105 can be improved if the messaging is synchronized and prioritized. Thus in a network, if devices on the network are active (connected to the network and powered) a method for providing communication between the devices is needed. Accordingly, at network power up or when a device is connected to the network and made active a communication channel is established for each interface (port) coupled to an active device. In one common example, a handshake signal is exchanged between the active and connected devices in accordance with a handshake protocol (of which many are known in the art) to establish a communication channel. Using the simplified network of FIG. 1A, a brief example handshake is described. For example at power up, a first source 101 and a second source 102 send handshake signals to branch device 105, as does first sink 103 and a second sink 104. The branch will then operate to establish an isochronous communication pattern by synchronizing the various devices. It should also be pointed out that the invention can be implemented using a multi-master communication (where either end can initiate a request transaction) or with single master communication where only one side (e.g., the Source Device side) initiates a request transaction. For the latter, the initiator (the Source Device) will periodically poll the Sink Device request. For example, Source Device may poll every other request transaction while the remaining request transaction is used for write to/read from the Sink Device. Other configurations can be employed as well.

At this point the inventor briefly describes a message communication environment for a device network. To begin, each link (e.g., 106-109) between networked devices preferably enables bi-directional communication between the pair of coupled devices (e.g., 101 and 105). In one such embodiment such bi-directional inter-device communication is supported by the auxiliary line 212 of a link connector 200. The timing of message propagation can be set in accordance with any desired protocol. Preferred embodiments use commonly employed timing architectures. In one implementation, the timing can be based on a USB standard communication format.

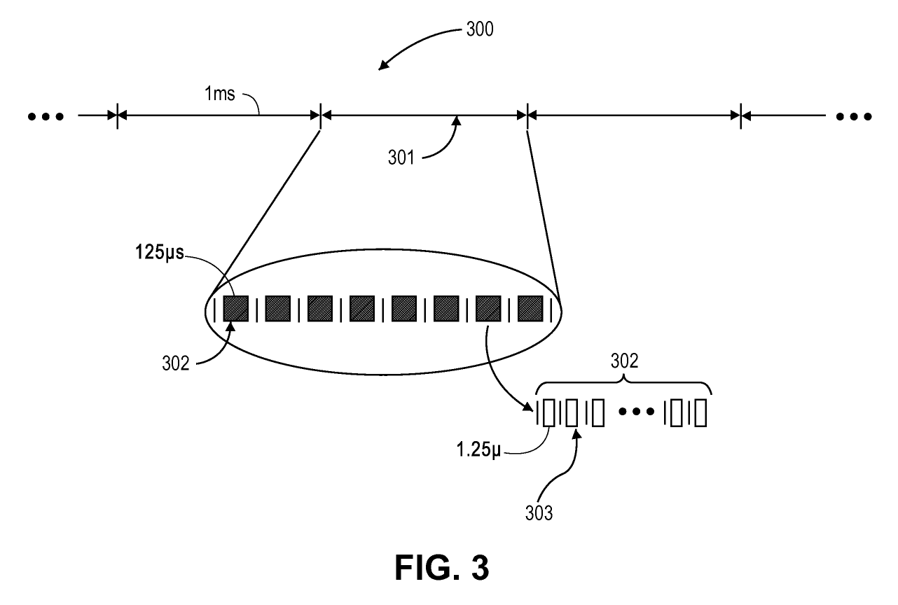

For example, FIG. 3 refers to a schematic depiction of communication timing scheme using a USB communication framework. USB protocols use a 1 millisecond (ms) frame period to transmit data messages. In some embodiments the frames are segmented into eight 125 microsecond (μs) sub-frames to enable high speed communications. In the present embodiment, a communication methodology is based on a stream 300 of 1 ms frames 301. Each comprising a series (eight) of 125 μs “heartbeat” periods 302. Thus, the communication scheme is compatible with USB timing. These “heartbeat” periods 302 are further segmented into 100 1.25 μs pulses or “micro-beat” periods 303 which can be used to deliver isochronous messages. Due to the very short micro-beat periods of this embodiment, a fine degree of messaging granularity can be achieved. Each micro-beat 303 defines a communication period allowing messaging between networked devices. In a related note, using such short micro-beats and having “turn around times” of on the order of 20 nanoseconds, the time period available to data messages is about 1 μs per micro-beat. Thus, each message can be quite small. It should be pointed out that, although this communication timing scheme presents some distinct advantages, the invention is in no way limited to only this timing scheme. It will be appreciated by those of ordinary skill that many other timing periods and timing approaches can be used in accordance with various embodiments of the invention.

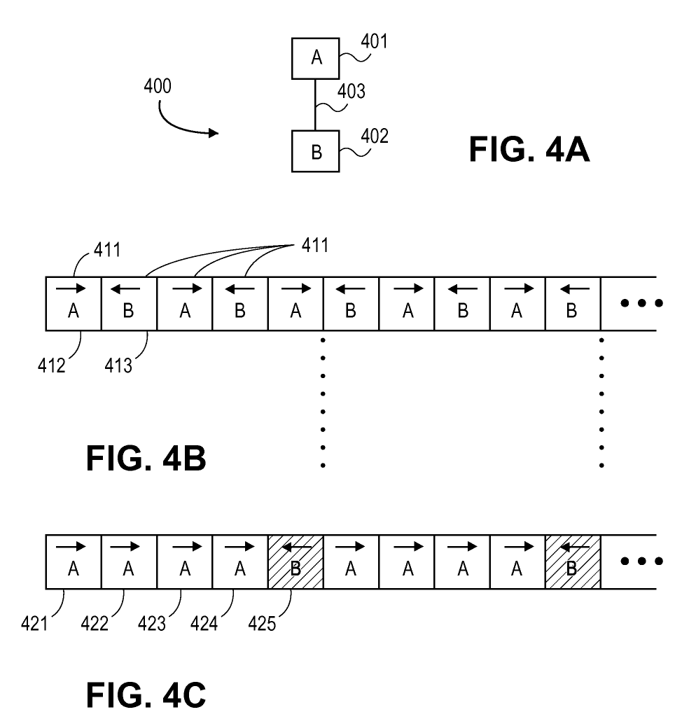

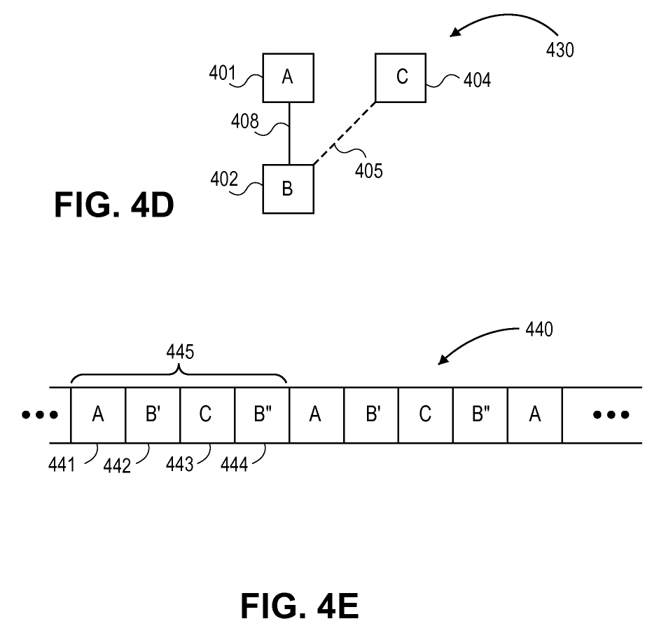

Referring now to FIG. 4A, a simplified network 400 of multimedia components 401, 402 is described. At power up, each of the devices establishes communication with connected and active devices (e.g., using a handshake protocol in accordance with any of a number of suitable protocols known to those of ordinary skill in the art). In one simplified explanatory example, all of the networked devices powered up together (thus becoming active at the same time). In other words the whole network is powered up at once. The devices 401, 402 exchange handshake signals to establish communication. Communications pass through link 403, which can be configured, for example, as in FIG. 2. Communication in one embodiment uses half duplex bi-directional auxiliary line 403 operating at a relatively high speed (e.g., 1 Mb/s (megabits per second)) to transfer data messages between the devices 401, 402. Once the handshake is complete devices can exchange data messages. Referring to again to FIG. 3, a sequence of micro-beats 303 are used to transmit messages between the two devices. FIG. 4B schematically depicts one example messaging pattern 410 for the two devices 401, 402. In this embodiment, an isochronous data flow is established. Such a pattern includes a sequence of specifically allocated message transmission periods. Each message transmission period is specifically dedicated to the transmission of data from a single device without interference from other device data transmission. In this embodiment one message transmission period corresponds to one micro-beat. Many other time intervals can be used to define each message transmission period. Here, a micro-beat 411 defines a set time interval of 1.25 μs for the message transmission period. In this depiction the intervals 411 are assigned in alternating fashion to enable communication back and forth between the devices. For example, a first micro-beat 412 is assigned for sending a data message from device A 401 to device B 402. The following micro-beat 413 is assigned for sending a message from device B 402 to device A 401. Thus, the devices alternate in their message transmission pattern.

Additionally, the number of messages sent by each component can be prioritized and the micro-beats can be allotted in other than a 50/50 distribution as shown in FIG. 4B. For example, in an implementation where device A 401 is a source device and device B 402 is a sink device one device may have a more urgent need for message transmission. For example, the source is commonly generating more message traffic than the sink device. In one example case, a source 401 is generating four times as much message traffic as the sink device 402. Accordingly, a messaging priority scheme can be adjusted to reflect that. FIG. 4C depicts a synchronization pattern suitable for accommodating the different priority scheme. In this example, the synchronization pattern 420 includes a set of predetermined time intervals configured to enhance messaging efficiencies. As before, the time intervals comprise micro-beats of 1.25 μs each. And each set of time intervals is five micro-beats. The micro-beats are arranged in a set that defines the synchronization pattern. Thus, the pattern 420 comprises a set of micro-beats 421-425 that defines the communication pattern between the two devices. Four micro-beats 421, 422, 423, 424, are allotted for sending messages from A to B for every one micro-beat 425 allotted for messages sent from B to A. Thus, 80% of the available time slots are allotted to device A for transmission to B with only 80% of the available time slots allotted for data messages from B to A. Thus, under this scheme device A 401 sends four messaged for ever message sent by device B 402. The above five micro-beat set defines only one possible embodiment of a synchronization pattern in accordance with the principles of the invention.

The inventor points out that there may be time periods where the devices have no messages to send. During those time periods, dummy data messages are transmitted instead to maintain synchronization and isochronicity for the messaging pattern. Thus, if device 402 (device B) has no data to send when its available time slot 425 arrives, a data message filled with dummy data (a dummy payload) is transmitted instead. Even more advantageously, the data messages can also contain messages instructing the devices to change the synchronization pattern. For example, in the case of FIG. 4C, the pattern can be changed to transmit messages from B to A once every ten micro-beats instead of once every five micro-beats. So the priority can be set or be dynamically adjusted depending on the needs of the system. This has further advantages as will be explained as follows.

Referring now to FIG. 4D, another simplified network is shown which expands upon that shown in FIG. 4A. In this network 430 an added device (device C) 404 is coupled to the network 430 using, for example, a link connector 405 of a type described in FIG. 2. In one approach, devices A and C (401, 404) are coupled with device B 402 at power up. During the handshake protocol, device B will receive signal from both A and C. Both A and C will attempt to begin sending data messages. As A and C send messages, device B, operating as a branch device can establish messaging synchronization. For example, as messages are sent by both A and C, B will send an interrupt message to one of A or C with an instruction to not send messages until authorized by B. The interrupt priority can be set in any manner desired by the user. For example, once transmission from C to B is interrupted, the communication between A and B can be synchronized. A synchronization pattern 410 like that of FIG. 4B can be established. Once the first pattern is established, device B will adjust the pattern to further accommodate messages from device C. Then communicate with device C authorizing to send messages to device B enabling communications between B and C as part of a synchronization pattern.

FIG. 4E illustrates a stream of data messages 440 between the devices of the network 430. FIG. 4E shows one simplified communication pattern 445 enabling messaging between device B and the devices coupled thereto (401, 404). In this example, an established pattern 445 begins with a first time interval 441 allotted to a data message sent from device A to device B. The time interval 441 (identified here with box A) can be, for example, a single micro-beat, or alternatively a string of contiguous micro-beats, or even one or more arbitrarily assigned time intervals. The next time interval 442 is allotted to a data message sent from device B to at least one of device A or C in accord with the synchronization scheme. In this example, the message microbeat 442 is allotted to a message sent from device B to device A (identified here with box B′). During a third time interval 443, a data message is sent from device C to device B (identified here with box C). And again, a fourth time interval 444 is allotted to a data message sent from device B to at least one of device A or B (or in some cases both) in accord with the synchronization scheme (identified here with box B″). In an alternative approach interval 442 could of course be allotted for message transmission from B to C instead of the B to A designated above. Similarly interval 444 could be allotted to communication from C to A. Thus, intervals 441-444 define a set of time intervals establishing a synchronization pattern 445. Thus, in one embodiment, each pattern 445 includes four micro-beats (441-444) allocated to communications between the devices. In this embodiment, a simple pattern is established whereby A sends a message to B and then B sends a responsive message back to A. Additionally, the pattern includes messaging from C to B with return messaging from B to C. Thus, half the messages are originated at B. Many other approaches and messaging distributions can of course be used.

Advantageously, as new devices are added to the network (or existing devices made active by powering up), the network is informed of their addition (e.g., using hot plug signals, via line 214, handshakes, or other communications), then the branch device (here, device B) to which a new device is coupled (e.g., device D 406) interrupts messaging from a new device 406 until messages can be sent to devices A and C informing them of an adjustment in synchronization pattern. The synchronization pattern is adjusted to accommodate the newly active network device D 406. Also, the synchronization of the pattern can be adjusted when a device is turned off or disconnected from the network. Additionally, when a device is disconnected or turned off, the network can be informed (e.g., via a hot plug signal or a shut down signal). For example, a shut signal can be sent to B as a device (e.g., device A) is disconnected, enabling the synchronization pattern to be altered to accommodate the new network configuration absent the disconnected device.

Such a messaging protocol and synchronization system is useful for sending many different types of information. Doubly useful because it does not require the use of main link bandwidth. Additionally, such data messages can include device capability information. Such information can include a wide range of information. Examples of data structures describing such capabilities are Extended Display Identification Data (EDID) or enhanced EDID data (and its many extensions) which can enable networked source devices and sink devices to become aware of the various capabilities of the networked devices. Other such data structures and formats include, but are not limited to I²C and the associated Data Display Channel (DDC) as well as the updated DDC2. This data enables the various network devices to format data to accommodate the device capabilities. This is helpful because in the current art, if a source device is connected, for example, to a number of sink devices through a branch device (e.g., a replicator or other branch device) only limited information is passed from the branch to the source. For example, if three sink devices are coupled with a branch device (e.g., a replicator), typically the branch device selects EDID information for only one of the devices. The EDID information for the single sink is all that is transmitted to a source. Thus, regardless of the capabilities of the other connected sink devices, only one set of attribute information is provided to represent the capabilities of all devices coupled with the branch device. The problem can be even worse where a multi-stream input is input to a branch device (e.g., a splitter), in order to correctly parse and distribute streams to the requisite ink devices significant EDID information is required. The required information is well beyond that supplied by a single EDID for a single one of the output devices. Thus, the full capabilities of some of the devices cannot be utilized. This problem becomes more dramatic as more multimedia devices and branch devices are networked together in larger networks.

Thus, the isochronous messaging methodologies set forth herein enable synchronization of many networked devices and messaging using the synchronized systems. They also enable a dynamic priority system that can prioritize the allotment of time intervals of the synchronization pattern to emphasize some devices over others. Also, it can dynamically adjust priorities in accordance with messages sent and received by the devices. Also, priorities can be adjusted as new devices are added to or removed from the network or existing devices are made active and inactive by powered on or powered off.

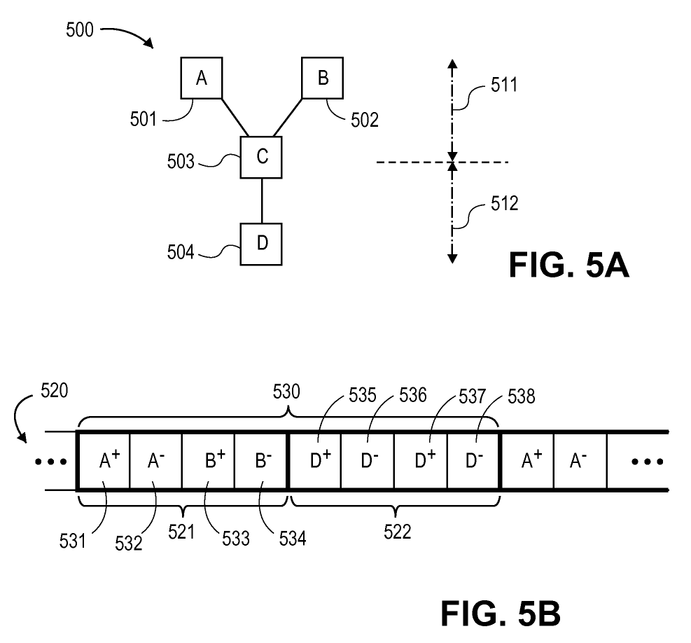

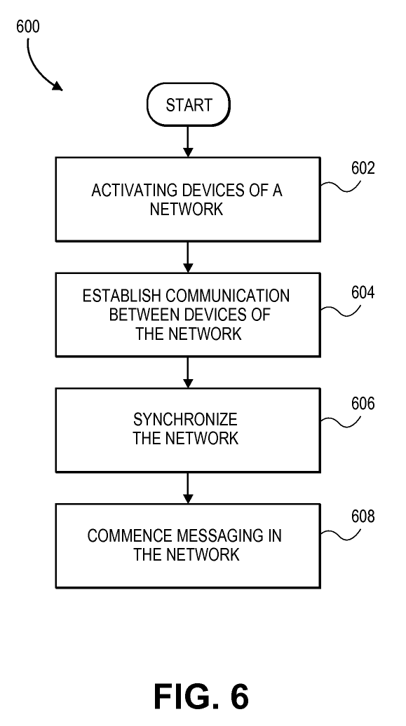

With the increasing complexity of devices and network arrangements communication between networked devices in a multimedia environment is becoming more complicated. As larger networks of devices are used, the number of devices has increased with increasingly complicated connections being made using a number of coupling approaches. FIGS. 5A, 5B, and 6 can be used to show one method of synchronization of message transmission between networked devices. For example, it can describe a mode of operation for network messaging in an audio/video/multimedia device network with such messaging being carried by a high speed auxiliary line of link connectors such as described in FIG. 2.

FIG. 5A depicts one example network suitable for implementing a messaging synchronization system in accordance with the principles of the invention. FIG. 5B illustrates a synchronization pattern suitable for use with the network of FIG. 5A and shall be discussed in detail below. Returning to the example network illustrated in FIG. 5A, a branch device 503 (C) is coupled with two source devices 502, 502 (A, B) to define an upstream end 511 of the network and a sink device 504 (D) defining the downstream end 512 of the network. The inventor points out that the upstream end of a network is generally the source end and the downstream end is generally associated with the sinks at the opposite end of the network.

FIG. 6 describes a brief flow 600 of operations enabling a message synchronization method. The operations begin by connecting the devices to the network and then powering up at least a portion of the devices on the network to make them active (Step 602). For example, the devices 501-504 of FIG. 5A are connected and powered up to activate each device. The devices are not active if they are not powered up and connected to the network 500.

The active devices establish communication channels with the other networked devices (Step 604). For example, using a handshake protocol. Commonly, each active device (powered up and connected with the network) engages with the other devices that they are coupled with. Referring to FIG. 5A, source 501 and source 502 each handshake with branch 503. Similarly, sink 504 handshakes with branch 503.

The process then establishes synchronization between the active devices on the network (Step 606). In a simple network (a pair of devices) a simple alternative messaging pattern can be easily established and executed to enable bi-directional messaging between the devices.

In order to establish synchronization among more complicated networks, the branch can selectively interrupt transmissions from each device except one and communicate with the devices in sequence. This can be done in accord with a fixed scheme, but typically the downstream communication (e.g., from device 504) is interrupted and typically only one upstream device (e.g., 501) engages with messaging between the branch.

In this example, using FIG. 5A, once all the traffic between devices and branch are interrupted (except one, e.g., 501), synchronization of communication can begin. In one example process, messaging can begin using equal message traffic between branch 503 and source 501. However, the initial messaging allocation is not limited to a 50/50 allocation of message traffic. It is simply one convenient embodiment with any desired message allocation distribution permissible. FIGS. 4A & 4B have already discussed one simplified scheme which could also be applied to messaging between 501, 502, 503 of FIG. 5A. In the depicted embodiment, once source 501 and branch 503 are synchronized another device can be added to the pattern. For example, the addition of another device (e.g., 502) typically alters the synchronization pattern to include both such upstream devices 501, 502. For example, FIG. 4E and the associated description illustrate one possible approach to data message distribution and allocation in a synchronization pattern for a pair of sources coupled with a branch. This can, in one example, synchronize the upstream portion 511 of the network. Messages can now be sent between the devices 501, 502, 503 in a synchronized pattern where message traffic to/from sink 504 is still on hold. The downstream portion 512 is now integrated into the synchronization pattern. Using the present example, once upstream synchronization is established, the network reconfigures the synchronization pattern to enable messaging with the downstream device D (504). The branch 503 interrupt of downstream communication (i.e., from sink device 504) is then terminated and bi-directional communications can begin between device C 503 and device D 504.

In one example, the message allocation can be arranged so that half of the messaging is done between the upstream devices and the branch with the other half operating between the downstream devices and the branch. In such an implementation half the messaging can be conducted between 503 and 504 with the other half being distributed in communication between 503 and 501/502. One example is shown in the schematically depicted stream 520 of message data of FIG. 5B.

Referring to the message stream 520 of FIG. 5B, in one common approach, the messaging concerning upstream devices 521 and messaging concerning downstream devices 522 is depicted. In the depicted pattern, messaging is divided equally between the two groups, it need not be so, it merely serves as a convenient illustration of the principle. In the upstream portion 521 of the synchronization pattern, the messaging can be broken into messaging between each upstream device 501, 502 and the branch 503 and vice versa. Similarly, the messaging includes communication between the downstream device 501 and the branch 503 and vice versa. Further referring to the message stream 520, in the depicted embodiment a first message transmission period 531 (e.g., a microbeat) is allotted to messages from sink A (501) to the branch C (503) (i.e., A+). A second period 532 is allotted to messages from branch C to sink A (i.e., A−). A third period 533 is allotted to messages from sink B (502) to the branch C (i.e., B+). A fourth period 534 is allotted to messages from sink A to branch C (i.e., B−). Thus, in this case, a set of four microbeats (531-534) defines messaging in the upstream portion 511 of the network. The synchronization pattern continues with a fifth microbeat 535, allotted to messages from source D (504) to the branch C (i.e., D+) and a sixth microbeat 536 allotted to messages from branch C to source D (i.e., D−). There is a repetition of this portion of the pattern (D+, D−) in the following two microbeats 537, 538. Many other patterns could of course be used. This overall synchronization pattern 530 encapsulates both upstream and downstream messaging and can be repeated down the message stream 520 until changed. The inventor points out that many possible distributions and allotments of the message transmission periods (i.e., microbeats) could be used to facilitate message communication in such a network.

It is important to point out that part of establishing the synchronization pattern (Step 606) can include adjusting the pattern in accord with changing conditions. For example, adding a device, removing a device, receiving a message from one or more of the devices requesting a greater (or reduced) proportion of allotted messaging time, a change in the default priority parameters or other alterations in the priority scheme. Thus, the pattern 530 can be adjusted to enable more or fewer message transmission periods to be allocated between the various devices of the network.

In any case, messaging proceeds (Step 608) once the synchronization pattern is established. It can also proceed in a partial fashion between those devices not on an interrupt mode awaiting synchronization.

### Relative Topology Mapping

Another very important feature in the invention includes methods, operations, and devices used to direct messages to a desired end point or final destination in a complex network of devices. In the above described embodiments, data message delivery is relatively uncomplicated. As networks get larger and more complicated and the device capabilities increase, message addressing and delivery becomes more complex. For example, in even the most basic of prior art networks, a basic USB or IEEE 1394 system requires a USB communication tree and a bus manager to manage even simple networks. Moreover, the addition (or removal) of devices from the network requires a complete remapping of and global reset of the existing address space for the network. Accordingly, to avoid these and other limitations in the existing art, there is a need for a simple, flexible, and adaptive message transmission methodology and the hardware and software to support it. The following paragraphs will describe one such approach but the principles of the invention are broader.

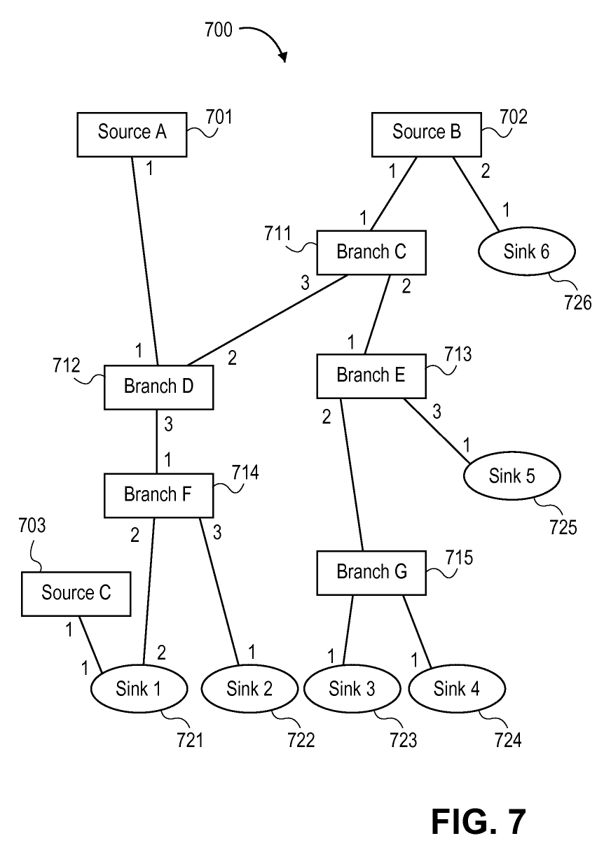

FIG. 7 depicts an example multimedia network useful for illustrating modes of operation for various methods and devices described below. Such a network can employ the synchronization methodologies and devices explained earlier in this disclosure. In this example, a network 700 includes three source devices (Source A, Source B, Source C) 701-703, five branch devices (Branch C, Branch D, Branch E, Branch F, and Branch G) 711-715, and six sink devices (Sink 1, Sink 2, Sink 3, Sink 4, Sink 5, & Sink 6) 721-726, all coupled to the network 700 using any of a number of methods or coupling methods (including, but not limited to the links of FIG. 2). Additionally, each device has a number associated with a communication port or interface for that port. In one example, Branch C (711) includes three interfaces 1, 2, & 3.

As indicated briefly above, establishing an effective message transmission path between, for example, Source B (702) and Sink 1 (721), is very cumbersome in the present art. Moreover, in the current state of the art, each time a device is added or removed from the network the entire network must be remapped and the system requires a global reset. The presently described approach offers a far more elegant and less cumbersome approach.

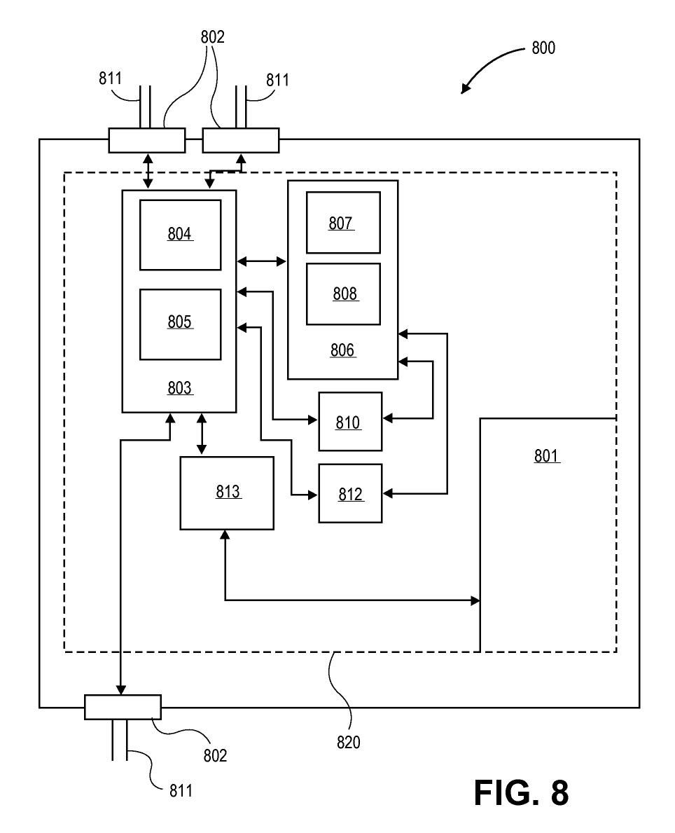

To further aid in explanation a brief reference is made to FIG. 8, which describes a generic multi-media device 800 as shown and described in this patent. The device 800 will typically have a chip based system 820 configured to support a number of different functions of the device 800. Such system can include functionality of some, all, or none of the modules and circuitry described below. The system can comprise a variety of electrically interconnected electronic IC systems or a system on a chip embodiment or comprise an array of separated sub-systems and modules integrated on circuit board or otherwise separately arranged.

The device 800 includes the hardware, software, and circuitry 801 required to enable its specific function. Typically, this can include a number of IC processor type devices, ASIC's, memory, and a variety of physical apparatus. In other words, in a sink embodiment the device 800 will have a functional module 801 perhaps including a display screen, hardware, and drivers configured to receive, decode, and enable presentation of audio-video information provided to the device 800. By way of another example, the device 800 can be configured as a branch device where the functional module 801 enables the required branch functionality. For example, the module 801 can have circuitry, physical apparatus, and software enabling hub functionality in the device 800 thereby enabling a number of inputs to be variably coupled to an assortment of outputs. In still another generalized example, the device 800 can be configured as a source device where the functional module 801 enables the required branch functionality. For example, the module 801 can have circuitry, physical apparatus, and software enabling the device 800 to function as a source device (e.g., a DVD player or a satellite radio receiver and so on). The idea is that these devices can be configured in any of a number of network connectible formats.

Each device 800 further includes one or more interfaces 802 configured to enable connection to the network. The interfaces can be simple link connector ports or other alternative connectors including, but not limited to, wireless connections and so on. In one embodiment, the interface 802 comprises a connector port compatible with a link 811 and including supporting apparatus, circuitry, software, etc. One example of a suitable link 811 is described in conjunction with FIG. 2. Thus, it can be as simple as an appropriately configured connector plug and a supporting circuit board. Also, each interface (port) has a unique port identifier that uniquely identifies that port as separate and distinct from other ports of the device 800.

Additionally, the interface(s) 802 are coupled with a message transport module 803 which commonly includes physical apparatus, circuitry, and supporting software configured to transmit and receive messages from the interfaces 802. The message transport module typically includes transmit circuitry 804 and receive circuitry 805 that can be arranged separately or as part of a transceiver device.

Signal received through the ports 802 and by the message transport module 803 can be processed by a message handling module 806. Such a module can include a variety of circuit elements and software elements as well as embedded firmware. The module will typically include “destination determination” circuitry 807 configured to determine whether received messages are in the desired final destination or whether they need to be forwarded to other destinations in the network. Also, the module can include address processing circuitry 808 configured to make adjustments and updates to the message relative path address of the message and also configured to access saved message relative path addresses located in memory devices of the device 800. These saved message relative path addresses enable messages to be sent to desired destinations in the network.

Moreover, the address processing circuitry 808 can include a path address modification module specially configured to modify and update path addresses (such as those contained in message headers). Such modification can be advantageously employed to enable message forwarded to other portions of the network. The functionality of this module is explained with greater detail hereinbelow. Additionally, such devices 800 can include an interface alignment module 810 configured to synchronize the signals passing in and out of the device 800 as described previously.

Additionally, the system typically includes a topology mapping module 812 arranged to receive network topology information (including but not limited to network address space information and device characteristics and capabilities) and process it to enable the formation of relative path addresses to the devices on the network. Such information can be stored in various memories forming part of the system 820. Additionally, module 812 can provide network topology information to other devices on the network enabling a complete picture of the entire network topology to be built. Such is important for the message transport methodologies discussed in the following paragraphs.

Once it has been determined that the message has arrived at the appropriate final destination (e.g., using 807), the message payload can be extracted from the data message and processed using a message processing module 813. Further actions based on the message can be taken. For example, an acknowledge message can be sent to the originating source. It should be pointed out that each of the above-referenced modules can comprise a combination of software and/or hardware which can include a variety of circuit elements, apparatus, software elements, as well as embedded firmware.

It should expressly be noted that the arrangements of each module are not limited to those depicted here. Although the arrows indicate one possible connection arrangement, many more are possible. Additionally, each module, or functional portions thereof, may be freely associated or integrated into any other module described herein. It is the functionality that describes the invention, not the specific arrangement. Additionally, each module can comprise at least some of a combination of software and/or hardware which can include a variety of circuit elements, apparatus, software elements, as well as embedded firmware. For example, software can be supported on a variety of media including, but not limited to tangible media, and also include embedded firmware resident in a piece of hardware. Moreover, the modules may comprise other implementations and arrangements.

Returning now to FIG. 7 (with brief reference to FIG. 8) the patentee further provides a methodology and approach suitable for sending a message to a destination and determining where it came from, thereby enabling return messages (e.g., acknowledge messages, responsive messages, data answering inquiries, etc.) to be sent to a source of origination.

In ne example, describes a message is transmitted between a source (e.g., Source B, 702) and a sink (e.g., Sink 1, 721). After messaging synchronization for the network has been established and network topology defined (an example of which is described below) data messages can be sent between most devices in the network. In particular, the system enables messaging between all devices capable of communication using a uni-directional link. An example of such a link is a main link configured for the transmission of AV data from source to sink (e.g., as described with respect to FIG. 2).

Each of the devices in the network has one or more interfaces (e.g., 802 of FIG. 8) which can be thought of as connection “ports”. Each port has a unique port identifier that enables a device to determine which port messages are received through or sent out of. For example, Source B (702) includes a pair of ports having unique identifiers 1 and 2. Analogously, Branch D (712) has three ports each having a unique port identifier (here, 1, 2, and 3). Thus, a relative path address from Source B (702) to Sink 1 (721) is: exit port 1 of Source B to Branch C, exit port 3 of Branch C to enter to Branch D, exit port 3 of Branch D to enter Branch F, exit port 2 of Branch F to finally enter Sink 1. Such a path can simply be abbreviated 1.3.3.2. This defines the relative path address to Sink 1 from Source B's point of view. Conversely, the return path from Sink 1 (721) back to Source B (702) has the address Sink 1 (2) to Branch F (1) to Branch D (2) to Branch C (1) which can be abbreviated 2.1.2.1. Thus, the path is mapped as a series of exit ports, each one leading to the next device in the chain of devices. Thus, a series of “hops” from one device to the next map a path to the final destination.

In another simple example, a path from Source B to Sink 6 (726) is short, merely port 2 or abbreviated as: 2. The route back can be even simpler in that there is only one active port for Sink 6. Thus, in this example case, the exit port need not even be specified all since there is only one choice.

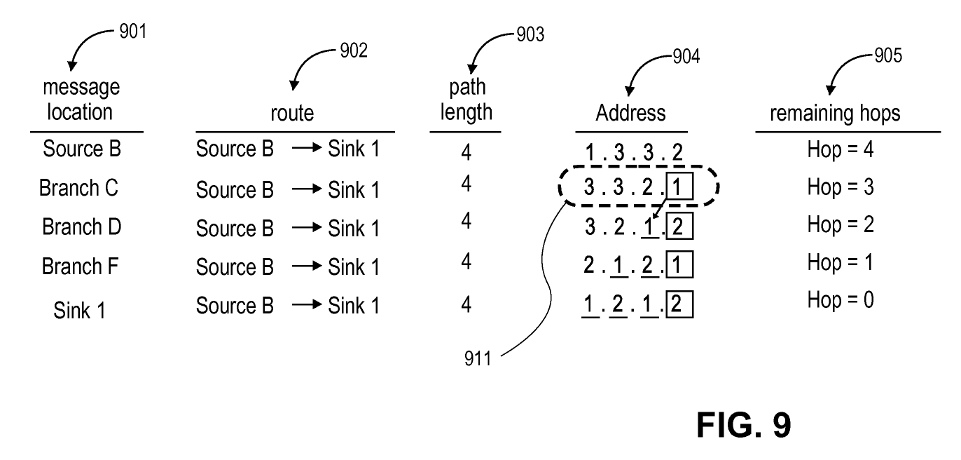

FIG. 9 includes a table that is illustrative of a simple message transmission process embodiment forwarding a data message from Source B to Sink 1. At the beginning a message is resident 901 at Source B with a route 902 being from Source B to destination Sink 1. The length of the communication path 903 is 4 “hops” with the string of sequential “hops” defining a relative path address (RPA) 904 of: 1.3.3.2. The message header includes a tracking indicator that is updated as the message progresses in the network toward its destination. An embodiment of this indicator is depicted in the table as a “remaining hop count” 905 which details how many “hops” the data message has remaining until it reaches its final destination. These pieces of information can be inserted into the data message enabling it to arrive at its intended destination. In particular, the relative path address and the tracking indicator (e.g., remaining hop count) can be integrated into data message by including this information into a message header. In typical operation, a device address processing module 808 will examine the RPA 904 of a message and determine where the message is to be forwarded. In one example, the address processing module 808 will examine a message header and then take a first byte of a relative port address from the header and identify the indicated port that the message is to be sent through. In our example, beginning at Source B, the first byte encodes port 1. Accordingly, the message will be sent through port 1 of Source B. Correspondingly, the message is received at Branch C.

At Branch C, a destination determination module 807 will determine if the message has reached its final destination. In one example, the hop count 905 can be used as a measure of final destination. In this embodiment, the final destination will be reached when the hop count=0. In other embodiments, other methods can be used to determine whether the final destination has been reached. At this point (Branch C) the hop count=3 so final destination is not reached.

Additionally, in this embodiment, the relative path address is adjusted to reflect the fact that the first hop has occurred. In one embodiment, this is done using the address processing circuitry 808. Thus, the hop count is adjusted from “4” down to “3” remaining hops. The relative path address is further updated. For example, the un-needed first port number can be deleted. Additionally, the path address can be updated by shifting (in this case) the path address to the left. This is shown in FIG. 9, by the first address change 911 which is depicted by a shift such that port 1 is deleted and remaining port identifiers 3.3.2 are adjusted to the left such that “3” is now the first byte.

In another advantageous feature, the invention further modifies the RPA by adding a portion of the return path to the path address 911. In this case, the added path information comprises the port number the message arrived through. Accordingly, port number “1” of Branch C is introduced. This is shown by the square in the path address 911. As stated above, these functions are typically performed by the address processing module 808 of the receiving device.

Thus, the module 807 has determined that Branch C is not the final destination. Additionally, module 808 has modified and updated the RPA and remaining hop count. Module 808 additionally reads the updated RPA to determine that the message is to be forwarded out of port “3”. Accordingly the message is transmitted out of Branch C via port “3” using transmit circuitry (e.g., 804).

The message arrives at Branch D where an analogous process occurs. A determination of final destination is made. The hop count is updated to “2”. Since the hop cop is not “0” the final destination is not reached. The address is updated to remove the used portion of the RPA (here, port 3 of branch C) and add a part of the return path (here, port 2 of Branch D). To that end, the hop count is updated to “2” and the RPA is modified by shifting the port identifiers again to the left and adding a new return path port number (here, port 2 of Branch D). Thus, the updated RPA is 3.2.1.2.

This continues on at Branch F where the hop count is updated to “1” and a determination of final destination is made. It is determined that a further hop is required so the address is updated to remove the used portion of the RPA (here, port 3 of branch D) and add a part of the return path (here, port 1 of Branch F). To that end, the RPA is modified by shifting the port identifiers again to the left and adding the new return path port number yielding RPA 2.1.2.1. The message is again forwarded (through port 2 of Branch F) to the next destination in the path.

When the message is received at Sink 1 (721) the hop count is updated to “0” and the destination determination module 807 of Sink 1 determines that hop count is zero and the final destination is reached. Further, the address is updated to remove the used portion of the RPA (here, port 2 of branch F) and add a part of the return path (here, port 2 of Sink 1). At this point, the complete return address (1.2.1.2) is specified so that any return messages have a completely specified return address to the originating device. To that end, the RPA is modified by shifting the port identifiers again to the left and adding the new return path port number. Depending on the nature of the message or established communication protocol a return message can be sent from the final destination (Sink 1) to the source of origination (Source B) using the updated RPA.

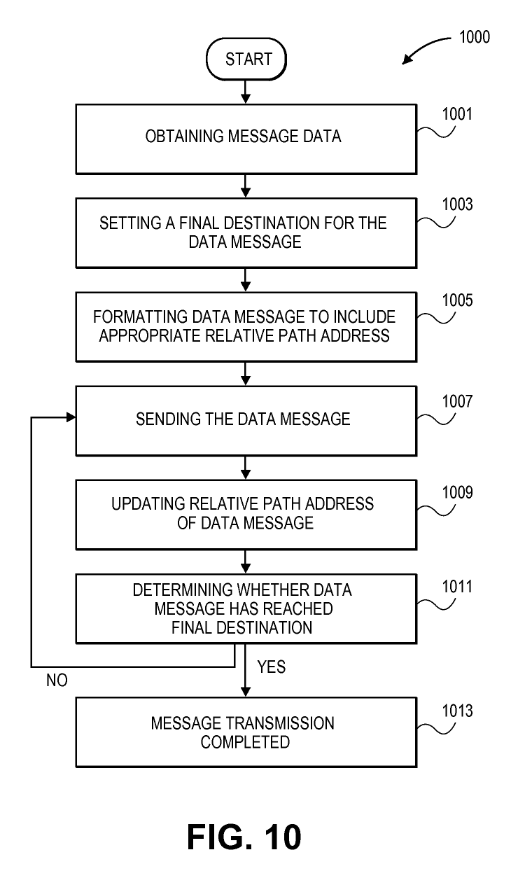

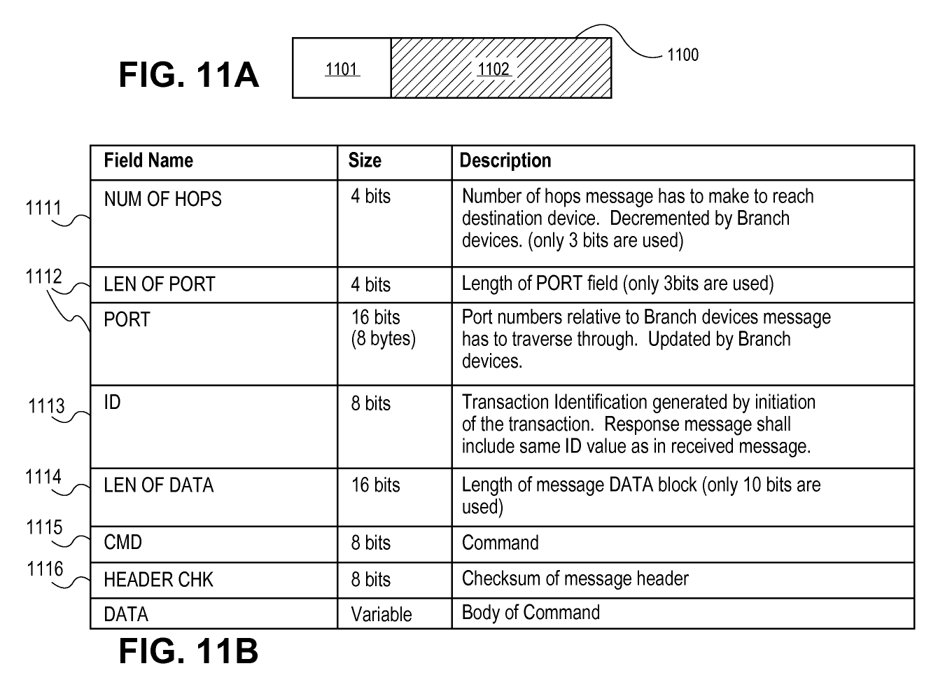

FIG. 10 provides a brief flow diagram 1000 illustrating the process discussed above. The process begins at an originating device on the network. The originating device constructs or is provided message data which is encapsulated in a data message including a header portion and a payload portion (Step 1001). The payload includes the substantive message data to be transmitted to the receiver. The header provides, among other things, routing information that enables the payload to be transmitted to the desired destination. Typically, the header includes an array of attribute and network information sufficient to enable the message to have the correct format and arrive at the desired final destination. The headers of course can be augmented with a large array of other information as desired by the user. FIG. 11 depicts one example of data formatting suitable for transmitting messages in a network in accordance with the principles of the invention.

Additionally, a determination of the destination of the data message is set (Step 1003). Typically, this is determined by the nature of the message, for example, if a message includes a change in synchronization priority between source A and sink B, a message from source A will have a destination associated with sink B.

Relative path information is then obtained, enabling message transmission to the correct final destination (Step 1005). Typically, each network device has stored in a device memory all relative paths required to communicate messages to each other device on the network. These stored relative path addresses are simply inserted in to an appropriate header of a data message and the data message payload and header can be sent to the desired location.

Once the message is constructed (i.e., header and payload), the message or series of messages is sent to the destination (Step 1007). Typically, this means the data message is transmitted through the first specified port identified by the relative path address. Thus, the message makes the first hop of its path. The messages are typically sent in accord with an established synchronization pattern.

At arrival, the relative path address is updated (Step 1009). As indicated above, a portion of the process is done through decrementing the initial path address and adding elements of the return path. In one embodiment, it means that the “hop” port passed through can be deleted from the address and the beginning of a return path can be constructed. Information suitable for generating a return path is also introduced into the relative path address.

Also, a determination of correct final destination is determined (1011). Typically, this includes updating the hop count (a process which can also be performed in previous step 1009). In one embodiment, this determination can be a simple determination as the whether the “hop count” in a message header is equal zero. This can be confirmed using any number of methods. Accuracy can be confirmed, for example, by simple using a checksum (or other check) in the header.

Where the message has not reached its final destination, it is forwarded through the next port as specified by the updated relative path address and Steps 1007, 1009, 1011 are repeated until the final destination is reached.

In contrast, when the message has reached its endpoint (Step 1013) no further message transmission is required. At this point, further processing can be conducted. For example, the message payload can be extracted and processed by the various components and elements of the receiving device. Associated actions are then taken by the receiving device. For example, acknowledge messages can be sent to the originating device confirming receipt of the message. “Resend” instructions can be sent to recapture corrupted or incorrect messages. If the message deals with priority changes or other alterations of synchronization or messaging, these can be incorporated. Any needed return messages can be sent back using the updated return path.

FIGS. 11A and 11B illustrate a typical example of one message embodiment. A data message 1100 includes a header 1101 structured into a number of different fields configured to enable unambiguous message parsing and delivery. And a message payload or body 1102 that contains the operative message information.

FIG. 11B depicts some of the possible header fields contemplated by the inventor. Importantly, the inventor points out that more or different field can be used in headers constructed in accordance with the principles of the invention.

The header may include a field 1111 associated with the hop count described above. This field can comprise any number of data bits. However, the inventor has found that 3 or 4 bit implementations are sufficient.

The header may also include fields 1112 associated with the relative address path as described above. Such can specify the length of port designation fields. And also include an updatable field that specifies the relative path that the message shall take to its final destination. This field is updated by the various devices that the message passes through on its way to its destination. These fields can comprise any number of data bits, however, embodiments having 8-9 bytes are found to be generally sufficient.

The header typically includes a field 1113 having a message identifier associated with the particular message. Such identifiers can also be used with return messages associated with an original message and are useful in particularly identifying messages. Such identifiers can also be used to sequence messages in some cases.

The header may include a field 1114 associated with the message payload. This message can be used to, for example, specify the length of the data payload 1102. This field can comprise any number of data bits. However, the inventor has found that 1 or 2 byte implementations are sufficient.

A short (e.g., 1 byte) command field 1115 can be specified. The inventor further points out that although a single byte is specified, the field can comprise any number of data bits.

The header may include a field 1116 associated with data integrity for the message 1100. For example, the field 1116 can include a simple checksum indicator. Such can be used to determine if there has been data corruption, an error, to enable encryption, and so on. Most commonly, it can be employed to insure there is not data corruption in the message header 1101. This field can comprise any number of data bits, but typically a single byte is sufficient.

### Discovery of Network Topology

Another important aspect of the invention is the methods and apparatus supporting the discovery of devices on the network and the mapping of the topology of the devices to obtain a relative mapping address space for the network. The following description makes further reference to the network 700 of FIG. 7. For purposes of this disclosure, an “upstream end” branch device is a branch whose upstream interfaces (input ports) are coupled only with source devices. In some alternative situations, the upstream ports of the upstream end may further be coupled to VESA version 1.1a compatible branch devices or a combination of branches and sources. Similarly, a “downstream end” branch device is that which the downstream ports are coupled only to sink devices (or alternatively, sinks and a VESA version 1.1a compatible branch device). Such version 1.1a devices are in compliance with VESA (Video Electronics Standards Association) Interoperability Guideline 1.1.a (such as may be obtained at www.vesa.org). The inventor points out that branch devices configured in other formats can be used as well.

In an example, Branch C (711) defines an upstream end where the input ports are coupled to upstream sources alone (Source C). Alternatively, Branch D 712 defines an upstream branch coupled with an upstream source (Source A (701)) and a branch (Branch C (711)). On the downstream end, Source B, Branch E, Branch F, and Branch G each comprise downstream end branches.

When the network 700 is powered on (in one example case when the whole network is turned on at once) communication channels are established for each coupled device. Thus, the coupled devices are aware of the immediately coupled devices but typically unaware of the deeper network connections. Such connections are derived using a network topology discovery process.

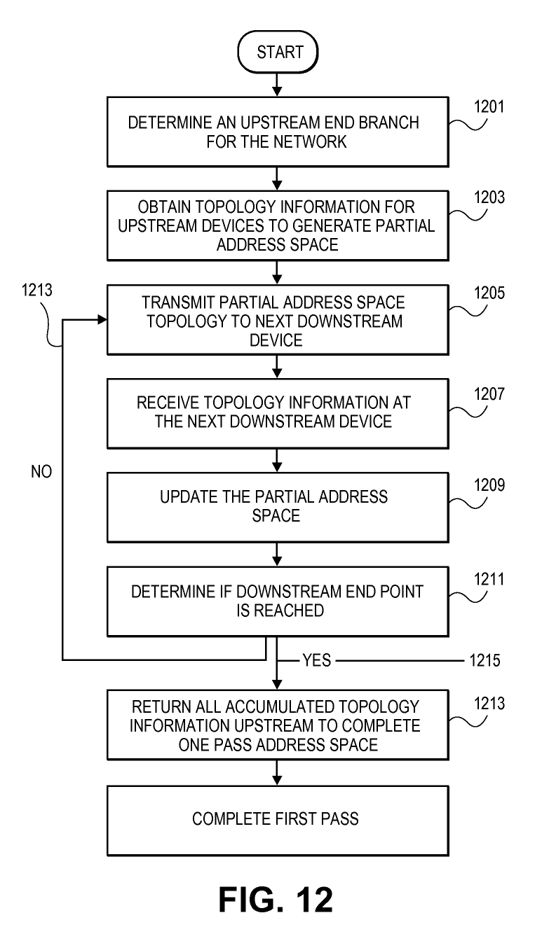

FIG. 12 is a brief flow diagram 1200 useful for describing a method embodiment for establishing network topology in accordance with the principles of the invention.

In one embodiment, a network determines which devices comprise the upstream end branches of the network (Step 1201). Once the devices are connected and the active devices have established communication (e.g., using a handshake protocol), the devices determine which branches are “upstream ends” of the network. The process can be accomplished using any of a number of possible approaches. For example, each branch device determines whether its upstream interfaces are directly coupled with sources. Those devices having upstream interfaces coupled only with source devices can be characterized as upstream end branches. As indicated above, other arrangements can be labeled “upstream ends” as well. However, in this example, such upstream end branch devices are those connected only with upstream sources. Thus, by one measure, Branch C (711) of FIG. 7 is the upstream end branch. In another embodiment, an “upstream end” branch can be any branch with an upstream interface connected with a source. For example, in such an implementation, both Branch C and Branch D are upstream end branches.

The discovery process begins in a top down fashion. Thus, the process begins with the most upstream end branch devices of the network initiating the topology discovery process. The most upstream branches initiate the process by obtaining information about all of the connected and powered (active) upstream devices (Step 1203). Such device connection information can include, but is not limited to, topology and interconnection information (e.g., relevant upstream port numbers) and device capabilities (e.g., EDID information, etc) as well as other relevant to message transmission and device capabilities. This upstream information is accumulated by the most upstream branches and then a partial address space is generated for the network. This partial address space is the beginning framework for a more complete network topology.

This partial address space information is forwarded downstream to the next downstream devices (Step 1205). Then next downstream device receives this information and then updates the information with both its own connection information and device capabilities as well as any new information concerning upstream topology (Step 1207). In one example, Branch C has collected its upstream topology information and builds a partial address space. This information is forwarded downstream to the next devices (e.g., Branches C & D). Branch D will then update the partial address space with its own device information as well as its connection information regarding Branch C (Step 1209). FIG. 12 shows that Branch D has its own upstream device (Source A) independent of Branch C. Accordingly, the upstream topology information for Branch D is further added to the partial address space. Thus, the device characteristics for Source A as well as its topology information are added to the updated address space.

A determination is made as to whether the downstream end of the network is reached (Step 1211). Where the device in question has further devices coupled with its downstream ports, the process continues (Step 1213). In other words the updating and forwarding processes (1205, 1207, 1209, 1211) continue downstream until the downstream end is reached (Step 1215). Once the downstream end of the network is reached, a relatively complete topology of the network is resident in the most downstream devices. Generally, at this point, each further upstream device has a less complete topology. Accordingly, the relatively complete topology information (including the associated device attributes) resident in the most downstream devices is returned back to the most upstream components, updating each one as it is returned upstream (Step 1217). Thus, each device in a given portion of the network has a sufficient picture of the network to enable unidirectional messaging (e.g., audio/video signals using a main link such as described in FIG. 2).

It should be noted that the one pass process explained above can be modified to provide a more complete picture of the network topology to each network device. After the first run through, the process is simply repeated and thus many devices not registered in the initial one pass (shown in FIG. 12) are added in the second pass up and down the network.

A typical example of one such process is explained as follows. The process begins at Branch C 711, the most upstream end of the network. The inventor points out that in some embodiments a portion of the process can also begin at Branch D which is also an upstream end.

Branch C 711 receives attribute characteristics from its upstream devices (e.g., Source B 702). Such information can include, but is not limited to, EDID information, device type, manufacturer, format information, timing and data rate information, as well as a wealth of other information useful for operation in a networked multimedia environment. This information is associated with the receiving port (here port 1 of Branch C) to build network topology information. Thus, this information associates the device information with the nature of the connections between them. Such information can be collectively referred to as network topology information which is then forwarded “downstream”. Thus, Branch C network topology information is sent to the most immediately downstream nodes (e.g., branches D & E). Consequently, both nodes D and E (711, 712) receive Branch C network information. Additionally, Branch D also receives topology and attribute information from its other upstream nodes (e.g., Source A 701, via port 1). Thus, each input port is associated with the appropriate device (i.e., port 1, with Source A information, and port 2, with Branch C information).

Also, the inventor points out that, Branch D can attempt to obtain network topology information from its upstream branches (including 711 (Branch C) and 701 Source A). However, commonly, Branch D typically instructs Branch C to “wait” until it obtains its upstream network information, at which point Branch C will forward the complete network profile downstream to Branch D.

Accordingly, the Branch C information is transmitted downstream in two paths. The Branch D path forwards the Branch D information downstream to node 714 (Branch F). Thus, Branch F has a more complete profile of the network than the more upstream nodes which have not yet discovered the full topography of the downstream portions of the network. The Branch D information includes the topology of Branch C and the topology upstream from Branch C as well as the Source A topology information. This information is augmented with Branch D attribute and topology information and then forwarded to node 714 (Branch F). Branch F adds its own topology information updating the upstream topology information and then provides this information to Sinks 1 and 2. Thus, Sinks 1 and 2 have a fairly complete picture of the topology of Branch D all the way up to and including Sources A and B.

In a similar fashion, the process of topology discovery and mapping continues for the Branch E path. The Branch C information is forwarded downstream to node 713 (Branch E). Thus, as discussed elsewhere, Branch E will have a more complete picture of the network than the more upstream nodes which have not yet discovered the full topography of the downstream portions of the network. The Branch D information includes the topology of Branch C and the topology upstream from Branch C. As yet, Branch E does not include topology regarding Sink 6.

Branch E augments the upstream topology information received from Branch C and then transmits it downstream to the nodes 725 (Sink 5) and 715 (Branch G). As for Sink 5, it is the most downstream end of the path associated with Sink 5. As to Branch G, the received upstream topology information is augmented with Branch G attribute and topology information and then forwarded to nodes 723, 724 (Sinks 3 and 4, respectively). Thus, Sinks 3 and 3 have a fairly complete picture of the topology of Branch E all the way up to and including Source B.

However, due to the incremental messaging used to map the network topology, the address space for the network is incompletely specified for devices further upstream. For example, Sink 1 has a complete picture of its entire upstream fork. Sink 1 is aware of a network topology that includes Source C, Branch F, Branch D, Source A, Branch C, and Source B and all of the connections between then and their associated attributes and capabilities. In contrast, the topology that Branch D is aware of is far more limited because it has no information about the downstream nodes. Accordingly, Branch D has network information complete only as to upstream Source A, Branch C, and Source B.

Once the topology mapping and discovery process reaches the most downstream ends the process begins again sending the accumulated topology information and associated data back upstream. Accordingly, each downstream end of the network sends a message upstream containing all of the topology information accumulated by the downstream end of the network. Thus, Sinks 1-6 each send information describing the network back to the upstream ends (Sources A, B, and C). This enables each device on the network to have a more complete picture of the network topology and capability.

However, even under this circumstance the address space for each network may not be complete due to the morphology of the network. However, each device on the network has enough topology information to support communication between devices using uni-directional links. In such a linked configuration, the unidirectionality of the links can prevent some messaging paths, for example such architecture prevents messaging between Source A and Source B (in accord with a uni-directional scheme).

The following provides an example of the address space for a pair of nodes (Branch C & Branch D) as determined using the process above.

TABLE 1

| | |
|---|---|
| Branch D Address Space | Branch C Address Space |

| | | | |
|---|---|---|---|
| Source A = | 1 | Source B = | 1 |
| Branch C = | 2 | Branch E = | 2 |
| Branch F = | 3 | Branch D = | 3 |
| Source B = | 1.1 | Source A = | 3.1 |
| Sink 1 = | 3.2 | Source F = | 3.3 |
| Sink 2 = | 3.3 | Sink 1 = | 3.3.2 |
| Source C = | 3.2.1 | Sink 2 = | 3.3.3 |
| | | Source C = | 3.3.2.1 |
| | | Sink 5 = | 2.3 |
| | | Branch G = | 2.2 |
| | | Sink 3 = | 2.2.2 |
| | | Sink 4 = | 2.2.3 |

With reference to Table 1 it can be seen that the Branch D Address Space does not encompass the entire network. In particular, it does not include the topology and device information associated with the Branch E devices (i.e., Branch E, Sink 5, Branch G, Sink 3, Sink 4). However, each address space is sufficient to enable the communication of data messages using uni-directional main links.

The inventor points out that a more complete network topology can be obtained using a second “pulse” of topology messages. To begin, Source B is informed of virtually all of the network topology and device attributes. Moreover, many of the downstream ends of the network have fairly complete topology information. By beginning at the upstream end a “second pass” through the network can be initiated. In such case, all of the accumulated topology information is sent by the upstream end branches downstream again to form a much more complete network picture. Because Source B has a far more complete network “picture” than either of Branch D or Branch E (both of which have not “discovered” each other yet) when it sends its downstream message it contains the entire network topology. Accordingly, the topology mappings of all of devices on the network are now known and each device now has a complete address space for the network. In other more convoluted network configurations, the second topology discovery “pulse” works quite to fill out the complete topology of the system.

In a further point, the inventor points out that when a device is removed from a network (or turned off) it is a simple matter to just delete those paths relating to the device. No global reset is required, all of the old address space and relative mapping unrelated to the removed devices are unaffected. Additionally, it is a simple mater to add a device. When a device is attached the network is informed (e.g., using a hot plug signal or some other related signal). Once the network is informed the same process as outlined in FIG. 12 is repeated. This will capture the topology information of the new device. Thus, the new network topology information will include new relative path addresses for each device capable of messaging to the new device as well the relevant device characteristics and attributes.

In a final note, network topology includes the relative path addresses between at least a portion of a set of networked devices. It also can include configuration data and other device characterization data. For example, such can include EDID information as well as device capabilities. Such capabilities configuration data can reference associated link status information, for example, whether the link is synchronized or not, for link maintenance purposes as well as device operational capabilities, formats and parameters.

In addition, embodiments of the present invention further relate to integrated circuits and chips (including system on a chip (SOC)) and/or chip sets as well as firmware for performing the processes just described. By way of example, each of the devices described herein may include an integrated circuit chip or SOC for use in implementing the described embodiments and similar embodiments. Embodiments may also relate to computer storage products with a computer-readable medium that has computer code thereon for performing various computer-implemented operations. The media and computer code may be those specially designed and constructed for the purposes of the present invention, or they may be of the kind well known and available to those having skill in the computer software arts. Examples of tangible computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter. Computer readable media may also be computer code transmitted by a computer data signal embodied in a carrier wave and representing a sequence of instructions that are executable by a processor.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. An integrated circuit system configured to operate in a networked multi-media device, the package comprising;
message transport circuitry adapted to transmit and receive data messages;
at least one communication line coupled with said message transport circuitry and having a unique port identifier for each communication line, wherein each communication line is associated with a port of a multi-media device;
destination determination circuitry for processing a received data message to determine if the data message has arrived at an intended final destination; and
address processing circuitry for modifying a relative path address associated with said data message.

2. The system recited in claim 1 wherein the address processing circuitry is modifies the relative path address of said data message to enable a receiving device to send a return message to an originating source for the message.

3. The system recited in claim 1 wherein the at least one communication line includes an input line and output line wherein each of said line has a unique local port identifier.

4. The system recited in claim 2 wherein the address processing circuitry is adapted to further modify the relative path address of a received message by adding a unique local port identifier associated with the input line that receives the data message.

5. The system recited in claim 1 wherein the system further comprises topology discovery circuitry adapted to characterize a network topology for at least a portion of a network to which the system is coupled.

6. The system recited in claim 5 wherein topology discovery circuitry of the system is configured to map relative path addresses to other devices coupled to the network.

7. A system as in claim 1 wherein address processing circuitry is configured to process data messages that include a data payload and a data header, the header comprising the relative path address and a tracking indicator.

8. A system as recited in claim 3 wherein said at least one communication line comprises a plurality of communication lines and further comprises interface alignment circuitry configured to synchronize the distribution of data messages passing through said interfaces in accordance with an isochronous synchronization pattern comprising sets of predetermined time intervals with each time interval designated for a data message and each set comprising a specified number of data messages allocated such that a designated number of said messages comprise one of, transmitted messages or received messages, each passing through specified ones of said interfaces.

9. The system recited in claim 8 wherein a number of said messages and a timing arrangement of said messages are arranged in said isochronous synchronization pattern in accordance with a priority scheme.

10. The system as recited in claim 9 wherein the interface alignment circuitry is further adapted to enable dynamic adjustment of the priority scheme.

11. An integrated circuit chip adapted for operation in a multimedia device, the chip configured to propagate data messages in the network through one or more communication ports each having a unique port identifiers, the chip configured to execute computer code instructions for performing the operations of:
receiving a data message from the network through an arrival port of the chip, the message including a relative path address that defines a message propagation path through the network enabling the message to reach a final destination;
modifying the relative path address of the data message to reflect the fact that the data message has moved from a prior location and reached said chip;
determining whether the chip is the final destination for the message;
where the chip is the final destination,
the contents of the data message are subject to further processing;
where said chip is not the final destination for the data message,
reading the modified relative path address of the data message to determine a next destination for the message; and
transmitting the data message through a departure port specified by the modified relative path address.

12. The chip as recited in claim 11, wherein at least part of the code comprises firmware embedded in circuitry of the chip.

13. An electronic device configured to operate in a multi-media network, the device comprising;
at least one interface adapted to connect the electronic device with other devices of a network;
message transport circuitry enabling said device to transmit and receive data messages through said at least one interface;
destination determination circuitry for determining if said electronic device is an intended final destination for a data message received by an interface of said at least one interface; and
address processing circuitry for modifying a relative path address associated with said data message.

14. The device recited in claim 13 wherein each interface includes a unique local port identifier that uniquely identifies each interface of the device.

15. An electronic device as recited in claim 14 wherein said at least one interface comprises a plurality of interfaces, and
wherein the device further comprises interface alignment circuitry configured to distribute and synchronize message transmission and receipt through said device in accordance with a synchronization pattern.

16. The device of claim 15 wherein a number of data messages and a timing arrangement of said messages are arranged in said synchronization pattern in accordance with a priority scheme.

17. The electronic device of claim 13 wherein the device further comprises topology discovery circuitry adapted to map an address space comprising a portion of a network coupled with the device, said topology discovery circuitry adapted to, establish a communication channel for each interface connected with an active network apparatus of the network;
receive topology information from each interface, the topology information including relative path addresses for at least some active network apparatus in communication with said interface; and
transmitting said topology information to at least some interfaces connected with the network, the topology information including the relative path addresses for each active network apparatus in communication with said device, thereby enabling data message transmission to network apparatus of the network using an associated relative path address to said network apparatus.

18. A method for propagating a data message through a multimedia network, the method comprising:
one of receiving and originating a data message for transmission in a network, said data message including addressing information suitable for specifying a communication path for transmission of the data message through a multimedia network;
determining, from a relative path address included in the addressing information of the data message, if the message has reached a final destination; and
for a message not at a final destination,
accessing the relative path address to determine an output line through which the message is to be transmitted, said relative message address further specifying a propagation path for the data message to travel until it reaches the desired final destination; and
transmitting the message through an exit port specified in the relative path address;
for a message at a final destination,
acting on the contents of the data message.

19. A method as in claim 18 further including updating the addressing information of the data message to account for the propagation of the data message through the network.

20. The method of claim 18 wherein the method operations are performed by an audio-video device forming part of a multimedia network.

21. A computer program product having computer readable instructions for propagating a data message through a multimedia network, the instructions comprising:
computer readable instructions for one of receiving and originating a data message for transmission in a network, said data message including addressing information suitable for specifying a communication path for transmission of the data message through a multimedia network;
computer readable instructions for determining, from a relative path address included in the addressing information of the data message, if the message has reached a final destination;
for a message not at a final destination, computer readable instructions for accessing the relative path address to determine an output line through which the message is to be transmitted, said relative message address further specifying a propagation path for the data message to travel until it reaches the desired final destination; and
computer readable instructions for transmitting the message through an exit port specified in the relative path address.

22. The product recited in claim 21 further including computer readable instructions for updating the addressing information of the data message to account for the propagation of the data message through the network.

23. The product recited in claim 22 wherein the computer readable instructions are embedded in the hardware of an integrated circuit.

24. A process for discovering the topology of the devices in a multimedia network, the method including the operations of:
a) establishing communication channels between a plurality of multimedia devices coupled together in a network;
b) transmitting device connection information from upstream devices of the network incrementally to downstream devices of the network;
d) incrementally updating the device connection information with further device connection information available at each downstream device until the updated device information reaches a downstream end device;
e) transmitting, back upstream from the downstream end device, the updated connection information until the updated connection information reaches an upstream end device;
f) incrementally updating the device connection information at each upstream device using information from the downstream end device until the updated device information is returned to said upstream end device; and
g) establishing a network address space using the updated device information resident at each device of the network.

25. The process recited in claim 24 wherein the updated device information resident at each device of the network includes relative path addresses enabling messages to be transmitted from one device of the network to another device of the network.

26. The process recited in claim 24 wherein the updated device information resident at each device of the network further includes information that describes the capabilities of devices forming part of the network.

27. A computer program product for discovering the topology of the devices in a multimedia network, the program having computer readable instructions comprising:
a) computer readable instructions for establishing communication channels between a plurality of multimedia devices coupled together in a network;
b) computer readable instructions for transmitting device connection information from upstream devices of the network incrementally to downstream devices of the network;
d) computer readable instructions for incrementally updating the device connection information with further device connection information available at each downstream device until the updated device information reaches a downstream end device;
e) computer readable instructions for transmitting, back upstream from the downstream end device, the updated connection information until the updated connection information reaches an upstream end device;
f) computer readable instructions for incrementally updating the device connection information at each device upstream using information from the downstream end device until the updated device information is returned to said upstream end device; and
g) computer readable instructions for establishing a network address space using the updated device information resident at each device of the network.

28. The process recited in claim 27 wherein the updated device information resident at each device of the network includes relative path addresses enabling messages to be transmitted from one device of the network to another device of the network.

29. The process recited in claim 27 wherein the updated device information resident at each device of the network further includes information that describes the capabilities of devices forming part of the network.
